(19) United States
(12) Patent Application Publication
(10) Pub. No.: US 2008/0016165 A1
(43) Pub. Date: Jan. 17, 2008

(54) METHOD OF CREATING, STORING, AND DISTRIBUTING ELECTRONIC MESSAGES

(76) Inventors: Jacquelynn R. Lueth, Encino, CA (US); William D. Garnet, Encino, CA (US)

Correspondence Address: Michael A. O'Neil;Michael A. O'Neil, P.C., Suite 820, 5949 Sherry Lane, Dallas, TX, 75225, US

(21) Appl. No.: 11/769,787

(22) Filed: Jun. 28, 2007

Related U.S. Application Data
(60) Provisional application No. 60/806,337, filed on Jun. 30, 2006.

(51) Int. Cl. G06F 15/16

(52) U.S. Cl. 709/206

(57) ABSTRACT

An electronic message is created by recording the speech and activities of a person situated within a kiosk. The message is stored and then transmitted to a recipient utilizing the internet.

### CROSS-REFERENCE TO RELATED APPLICATION

Applicant claims priority based on provisional patent application Ser. No. 60/806,337 filed Jun. 30, 2006, the entire content of which is incorporated herein by reference.

### TECHNICAL FIELD

This invention relates generally to the creation, storage, and distribution of messages, and more particularly to the creation of electronic audio/video messages for distribution over the internet.

### BACKGROUND AND SUMMARY OF THE INVENTION

Since its introduction at the dawn of the computer age the internet has gained in popularity tot point that it is now used almost exclusively for the distribution of a wide variety of types and kinds of messages, including in particular personal messages. Notwithstanding its widespread popularity the internet is seldom used for the distribution of messages which include images such as videos and electronic photographs. Simply put, most internet users do not have either the equipment or the skills that are necessary to attach electronic images to their internet transmissions.

Two approaches for remedying this problem are currently available. For example, many currently available cell phones include built-in cameras which are capable of making and storing electronic photographs and videos. Cell phones having built-in cameras are also capable of transmitting electronic images made by the cameras to other cell phones. However, the transfer of electronic images from cell phones to a computer so that the images can be transmitted utilizing the internet is beyond the capability of all but the most technologically sophisticated users.

It is also known to provide both business and personal computers with electronic cameras. Typically the camera is mounted on a monitor associated with the computer and can be used to generate either videos or electronic photographs. The resulting images are then stored in the computer for subsequent transmission utilizing the internet. Despite the foregoing capabilities computers equipped with electronic cameras have not gained widespread acceptance.

The present invention comprises a method of creating, storing, and transmitting messages having electronic images associated therewith which overcomes the foregoing and other difficulties which have long since characterized the prior art. In accordance with the broader aspects of the invention a kiosk is provided at a public location such as a mall, transportation terminal, etc. The kiosk is provided with an audio/video recording system for creating and recording messages including both audio and video components. The recorded message is transmitted to the intended recipient by means of the internet.

In accordance with more specific aspects of the invention operation of the kiosk requires payment of a fee for the utilization thereof to record an audio/video message. In accordance with one embodiment of the invention the fee charged for utilization of the kiosk includes delivery of the recorded audio/video message by means of the internet. The recorded message may be sent directly to the intended recipient. Alternatively, the recorded message is sent to the purchaser thereof who in turn sends the recorded message to the intended recipient. In accordance with another embodiment of the invention a kiosk operator retains possession of the recorded message and subsequently utilizes the internet to transmit the message pursuant to instructions received from the person or persons that utilized the kiosk to prepare the message and the receipt of a previously agreed upon fee.

### BRIEF DESCRIPTION OF THE DRAWINGS

A more complete understanding of the present invention may be had by reference to the following Detailed Description when taken in connection with the accompanying Drawings, wherein:

FIG. 1 is a diagrammatic illustration of a typical implementation of the invention; and

FIG. 2 is a flowchart comprising certain of the steps involved in the practice of the invention.

### DETAILED DESCRIPTION

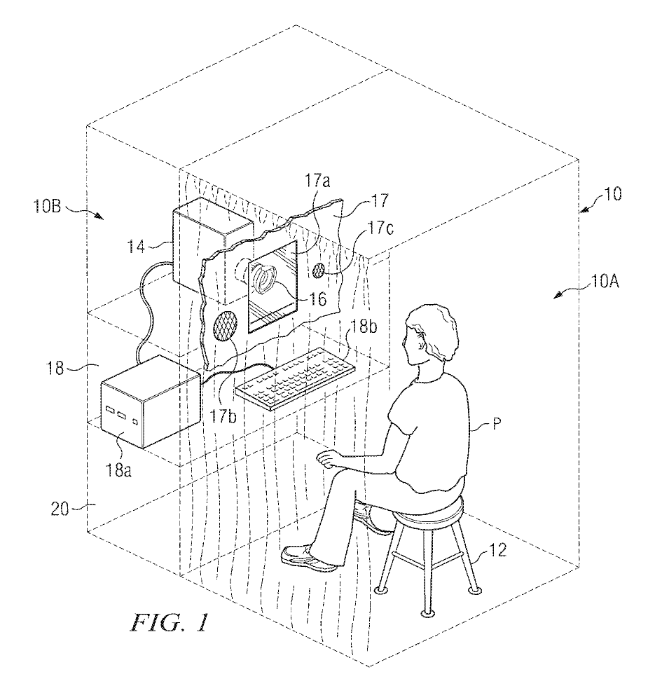

Referring now to the drawings, and particularly to FIG. 1, a typical implementation of the present invention is illustrated. A kiosk 10 is situated at a location selected by the operator thereof, typically a location frequented by large numbers of people such as a mall, a transportation terminal, etc. The kiosk 10 is configured to receive one or more persons P wherein. Preferably the kiosk stand is configured such that the person P may either sit or stand during the preparation of an audio/video message. The kiosk is preferably provided with a seating device 12 such as a stool or chair which can be positioned within the kiosk 10 if the person P elects to sit during the preparation of the audio/video message or removed from the kiosk 10 if the person P elects to stand during the preparation of the audio/video message.

The kiosk 10 is divided into a recording chamber 10A and an equipment chamber 10B. The person P desiring to make an audio/video recording for subsequent transmission utilizing the internet is positioned within the recording chanter 10A and remains therein throughout the preparation of the audio/video message. An audio/visual recording device 14, which may comprise a typical TV camera equipped with audio recording facilities or any other type of video recording device equipped with audio recording facilities is situated within the equipment chamber 10B. The audio/video recording device 14 typically includes a lens positioned behind a window or screen 17a comprising part of a wall 17 which separates the chambers 10A and 10B. The wall 17 also supports a speaker 17b and a microphone 17c.

The equipment chamber 10B further comprises a compartment 18 which houses one or more devices adapted to receive an audio/video recording from the audio/video recording device 14, to record the received audio/video message, and to transmit the received audio/video message utilizing the internet, for example, a computer 18a and a keyboard 18b. Various types and kinds of devices for receiving a recorded audio/video signal and for transmitting the received audio/video message are well known in the art.

The equipment chamber 10B may also be provided with a compartment 20 for receiving HVAC equipment adapted to control the environment within the recording chamber 10A during the preparation of a message therein. Depending upon the environment in which the kiosk 10 is used, the provision of dedicated HVAC equipment for controlling the atmosphere within the recording chamber 10A may or may not be necessary.

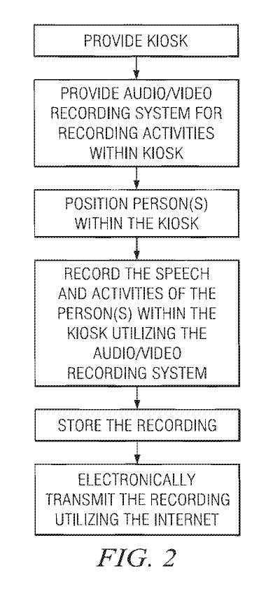

A method of creating, storing, and distributing electronic messages comprising the present invention is partially illustrated in FIG. 2. It includes the steps of providing a kiosk, providing an audio/video recording system for recording activities within the kiosk, positioning one or more person within the kiosk, utilizing the audio/video recording system to record the speech and activities of the person(s) within the kiosk, storing the recorded audio/video message, and transmitting the audio/video message to the intended recipient utilizing the internet

As will be understood by those skilled in the art, the kiosk of the present invention is adapted for fully automatic operation. In such instances the kiosk is activated by insertion of a valid credit or debit card into a card reader. The user of the kiosk then inputs the email address of the intended recipient using a keyboard or other data input device. Facilities are provided for reviewing the message prior to transmission thereof.

In accordance with a first embodiment of the invention a fee is paid for use of the kiosk in the preparation of a message that is transmitted over the internet to an intended recipient includes the delivery of the message from the kiosk to the recipient at the conclusion of the recording session. In accordance with a second embodiment of the invention an operator of the kiosk retains the recorded audio/video message. Whenever the customer desires to transmit the message to a selected recipient the customer provides the operator with the email address of the recipient and pays a transmittal fee to the kiosk operator. At that point the kiosk operator utilizes a computer to transmit the message to the designated recipient util zing the internet.

Although preferred embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

1. A method of creating, storing, and distributing electronic messages comprising the steps of:
providing a kiosk;
providing an audio/video recording system or recording activities within the kiosk;
positioning at least one person within the kiosk;
recording the speech and activities of the person within the kiosk utilizing the audio/video recording system;
storing a message comprising the recording of the speech and activities of the person while in the kiosk;
providing a computer; and
utilizing the computer to transmit the stored message to a recipient by means of the internet.
